(19) United States
(12) Patent Application Publication
(10) Pub. No.: US 2004/0187151 A1
(43) Pub. Date: Sep. 23, 2004

(54) Method, apparatus and system for managing recorded personal video recorder content

(76) Inventor: Robert A. Dunstan, Forest Grove, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/393,889

(22) Filed: Mar. 21, 2003

(51) Int. Cl. H04N 5/445; G06F 3/00; G06F 13/00; H04N 7/173; H04N 7/16

(52) U.S. Cl. 725/55; 725/133; 725/141

(57) ABSTRACT

Previously recorded personal video recorder (“PVR”) content may be managed using electronic programming guide (“EPG”) metadata. According to an embodiment, a PVR may download EPG metadata corresponding to previously broadcast programs. Specifically, in one embodiment of the present invention, the EPG metadata corresponding to the previously broadcast programs comprises only metadata pertaining to programming changes. This change metadata may be compared against a previously recorded content list to determine whether previously broadcast content was changed. If the change metadata matches an item on the previously recorded content list, the item is identified as a changed item, and the PVR may be programmed to take action to manage this changed item.

### FIELD OF THE INVENTION

The present invention relates to the field of electronic programming guides (“EPGs”), and, more specifically, to a method, apparatus and system for using EPG metadata to manage recorded personal video recorder (“PVR”) content.

### BACKGROUND

Use of personal video recorders (“PVRs”) has increased significantly in recent years. Similar to videocassette recorders (“VCRs”), PVRs may be used to record current or future program broadcasts. Instead of the video-tapes used by currently available analog VCRs, however, PVRs are typically digital devices that store recorded programs in digital form, on one or more storage devices.

Viewers may utilize electronic programming guides (“EPGs”) to program their PVRs. EPGs are obtained electronically from a remote location over a network such as the telephone network, TV cable system or the Internet. They comprise programming information, generally presented to viewers in a scrolling chart format. Thus, for example, a typical EPG interface today may be displayed as a chart comprising viewing times on one axis and channels on a second axis. Within this chart, viewers may scroll through all available channels to determine what programs are being broadcast on various channels at different times of the day. To view and/or record a current or future program, a viewer typically enters a selection via a remote control device. The selection either begins recording the program immediately (e.g., if the program is currently being broadcast) or, if the program is broadcast at a future time, designates the future broadcast to be recorded.

One limitation of current EPGs is that viewers may only access current and future programming information. Once a program is over, the EPG information pertaining to the program is no longer available to the PVR and/or to the viewer. This limitation affects the ability of PVRs to address programming changes and optimize recording.

### BRIEF DESCRIPTION OF THE DRAWINGS

The present invention is illustrated by way of example and not limitation in the figures of the accompanying drawings in which like references indicate similar elements, and in which:

FIG. 1 illustrates an existing PVR system;

FIG. 2 illustrates one embodiment of the present invention; and

FIG. 3 is a flow chart illustrating an embodiment of the present invention.

FIG. 4 is a flow chart illustrating an entire PVR system according to one embodiment.

### DETAILED DESCRIPTION

Embodiments of the present invention enable PVRs to access and utilize information pertaining to previously broadcast content to manage recorded PVR content. The term “broadcast” as used in this specification shall not be limited to traditional broadcasting methods and shall include any and all transmission methods capable of transferring and/or sending content and/or metadata from a source (e.g., a content source and/or a metadata source) to a destination (e.g., a PVR) or vice versa. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

According to one embodiment of the present invention, EPGs may include metadata pertaining to previously broadcast programs, in addition to current and future broadcast programs. The term “metadata” is well known to those of ordinary skill in the art and includes all data used to define or describe program information. PVRs typically utilize program metadata to determine and/or implement a viewer's viewing and recording selections. Thus, for example, if a viewer indicates that he or she is interested in recording the program “Friends,” a PVR may scan all metadata provided by the EPG to determine which channel broadcasts the program, the appropriate broadcast times, and any other information necessary to program the PVR for recording. Certain PVRs may require additional input from the viewer in order to properly select the program (e.g., if there are multiple showings of a program on different channels, as typically occurs with syndicated programs or to resolve conflicting user requests).

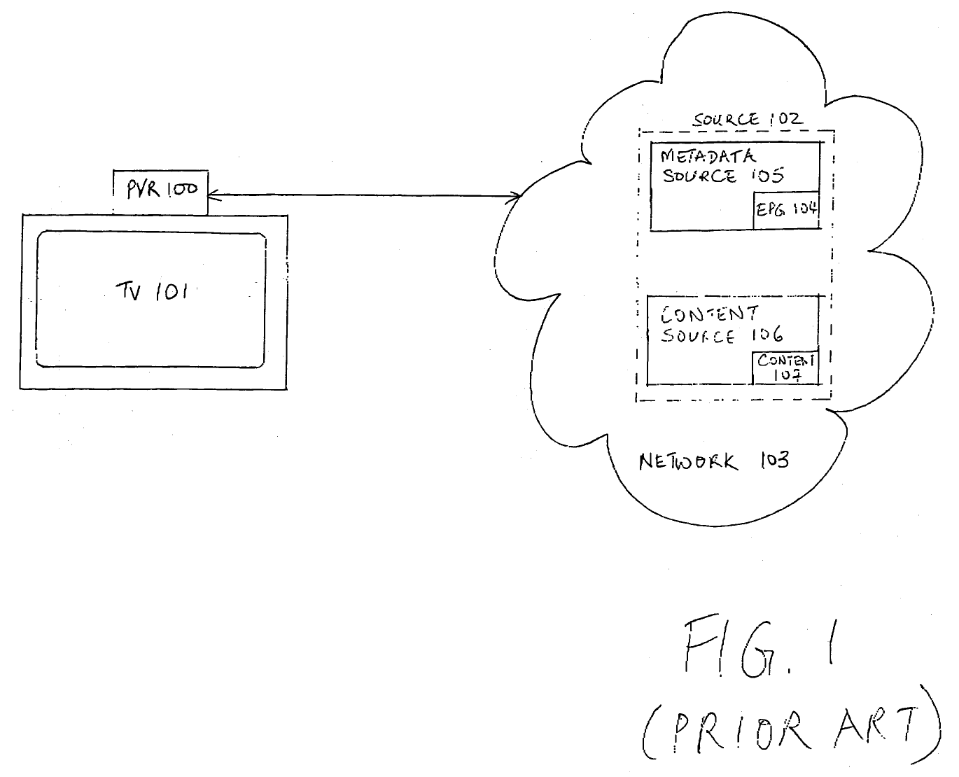

FIG. 1 illustrates an existing PVR system. PVR 100 may be coupled via a network (“Network 103”) to a television (“TV 101”) and to one or more content and metadata sources (illustrated collectively as “Source 102”). As illustrated, Source 102 may include a metadata source (“Metadata Source 105”) containing EPG 104 and a content source (“Content Source 106”) containing Content 107. Although Metadata Source 105 and Content Source 106 are illustrated conceptually as originating from a single source, it will be readily apparent to those of ordinary skill in the art that Source 102 may in fact comprise one or more data processing devices and that Metadata Source 105 and Content Source 106 may reside on the same or separate devices. EPG 104 may be transmitted to PVR 100 in conjunction with TV broadcasts and/or independent of TV broadcasts. Network 103 may include any transmission medium capable of supporting TV broadcasts and/or EPG metadata. It will be readily apparent to those of ordinary skill in the art that Network 103 may comprise multiple networks (e.g., a network that supports TV broadcasts and a separate network that supports EPG metadata). It will additionally be apparent to those of ordinary skill in the art that PVR 100 may be coupled to Source 102 via a variety of wired and/or wireless connections such as a low-bandwidth telephone line, and/or high bandwidth connections such as a cable connection, over the air broadcasts, satellite links and/or Digital Subscriber Loop (“DSL”) connections. In embodiments of the invention, these connections may facilitate transfer of audio and/or video data (e.g., for TV broadcasts), and/or EPG metadata.

In one embodiment, PVR 100 may be a set-top box. In other embodiments, PVR 100 may comprise a personal computer (“PC”) and/or other data processing system. Although PVR 100 is illustrated as being coupled to TV 101, other displays such as computer monitors may also be used. Additionally, although a particular arrangement of devices is shown in FIG. 1, it will be readily apparent to those skilled in the art that other arrangements are also possible. For example, the functionality of PVR 100 and TV 101 may be combined into one device. In an alternate example, PVR 100 may be coupled to TV 101 via a wireless connection.

PVR 100 may download a new/updated EPG 104 periodically, e.g., once a day or once every 48 hours. Upon receipt of newly downloaded EPG 104, PVR 110 may utilize the new and/or modified metadata information, if any, to adjust its future recording schedule accordingly. Thus, for example, if newly downloaded EPG 104 reflects that “Friends” has been moved from its regular time slot at 8 p.m. on Thursday to 1 a.m. on Friday morning, to accommodate a rebroadcast of the President's State of the Union address, PVR 100 may utilize this information and automatically adjust its future recording schedule to ensure that it records the “Friends” episode at 1 a.m. on Friday morning instead of during its regular 8 p.m. slot on Thursday evening.

If, however, in between downloads of updated EPG 104's, a program is delayed and/or cancelled for any reason (e.g., unexpected live news coverage and/or overtime in a broadcast sporting event), a current PVR 100 may nonetheless record whatever program is broadcast during the originally scheduled time slot (e.g., 8 p.m. on Thursday for “Friends”) because it does not have access to the updated programming metadata. Thus EPG 104's metadata may continue to reflect that “Friends” is being broadcast and PVR 100 records the program broadcast during that time slot. At the end of the time slot, PVR 100 stops recording, and the metadata for the completed broadcast is typically no longer available. PVR 100 stores the recorded news broadcast or the overtime broadcast of the sporting event until the viewer views and/or erases the recording.

As a result of this scenario, PVR 100 may record and store content that the viewer may not have requested (e.g., the unexpected news broadcast) and list inaccurate information pertaining to the recorded content. In other words, the incorrect content may take up space on PVR 100's storage device while the recorded content list on PVR 100 (which is based on the incorrect EPG metadata) may indicate to the viewer that the correct program was recorded. If, for example, the viewer does not check his or her PVR for a few days (e.g., the viewer is on vacation) and has pre-programmed PVR 100 to record a number of different programs, PVR 100 may record the incorrect program and run out of storage space to record additional programs. If, however, the viewer does check the recorded content list on PVR 100, the listing may indicate that the correct program was recorded, thus not prompting an action on the viewer's part. As a result, the recorded content that the viewer did not request may continue to take up space on PVR 100's storage device, and potentially preclude PVR 100 from recording other programs, while tricking the viewer into believing he or she has recorded the correct program. The viewer may not be aware of the incorrectly recorded content until he or she attempts to view the content, at which point it may be too late to attempt to find and record the correct content. Viewers today have little recourse to address these limitations.

According to one embodiment of the present invention, PVRs may download EPGs containing metadata pertaining to previously broadcast program changes. PVRs may utilize this metadata to determine whether previously recorded content corresponds to the actual program recording requested by the viewer or recorded speculatively by the PVR based on other criteria (e.g., based on the viewer's taping habits). If not, the PVR may be programmed to take appropriate action, either automatically and/or as instructed by the viewer.

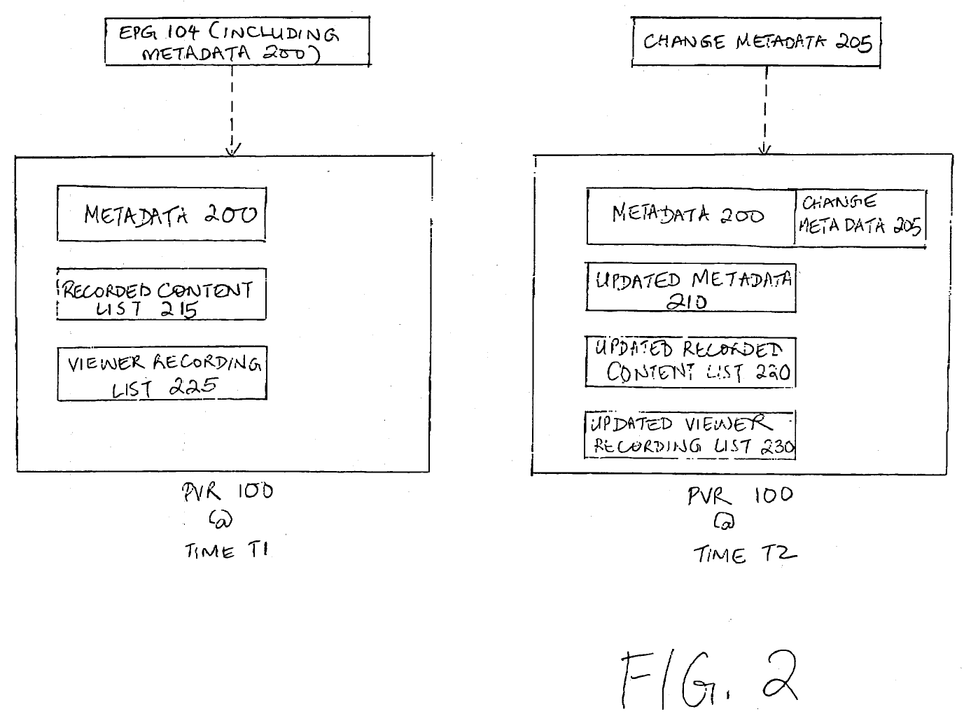

FIG. 2 illustrates one embodiment of the present invention in further detail. As illustrated, at time T1, PVR 100 downloads EPG 104 including all its metadata (“Metadata 200”). At time T2, PVR 100 downloads a second set of metadata (“Change Metadata 205”). According to one embodiment, Change Metadata 205 includes only information pertaining to changes in the programming schedule. In an embodiment, Change Metadata 205 may include change metadata pertaining only to previously broadcast programs. In an alternate embodiment, Change Metadata 205 may include change information pertaining to future program broadcasts, as well as previously broadcast programs. According to an embodiment of the invention, upon receipt of Change Metadata 205, PVR 100 may compare Change Metadata 205 to Metadata 200 to identify items in the programming schedule that have changed. Metadata 200 may then be updated (illustrated as “Updated Metadata 210”) to reflect the updated programming schedule, including the changed items.

In yet another embodiment, Change Metadata 205 may be similar to Metadata 200, i.e., Change Metadata 205 may comprise metadata for the entire programming schedule, including any changes since the previous download of EPG 104 containing Metadata 200. In this embodiment, Change Metadata 205 replaces Metadata 200 as Updated Metadata 210. As will be apparent to those of ordinary skill in the art, this embodiment may be highly impractical for PVR 100 if coupled to Source 102 via bandwidth limited connections such as telephone lines. In a high bandwidth environment, however, entirely new EPG 104s may be downloaded without significantly impacting the performance of PVR 100's system.

According to one embodiment, the time period between T1 and T2 may be selected and/or defined by the user. This embodiment may be implemented in a PVR system that enables the viewer to program PVR 100 to “pull” EPG 104 information from the system servers when manually requested by the viewer and/or at viewer-defined intervals. This embodiment may be especially suitable when PVR 100 is coupled to Source 102 via a bandwidth-limited connection such as a telephone line. PVR 100 may determine when the telephone line is available and request a download of updated EPG 104. Alternatively, in a “push” system, the Source 102 may contact PVR 100 at predetermined time periods T1 and T2 (typically determined by the EPG provider). In this embodiment, once Source 102 is connected to PVR 100, Source 102 may broadcast new EPG information to PVR 100 at predetermined intervals defined by the EPG provider. This embodiment may be especially suitable when PVR 100 is coupled to Source 102 via a high bandwidth connection. The concept of “pull” and “push” systems is well known in the art and further description thereof is omitted herein in order not to unnecessarily obscure the present invention.

According to one embodiment of the present invention, after being downloaded to PVR 100, Change Metadata 205 may be compared against a list of previously recorded content on PVR 100 (“Recorded Content List 215”). Recorded Content List 215 comprises programs previously selected by the viewer for recording or automatically recorded based on various criteria (e.g., the viewer's viewing habits). Upon comparison, PVR 100 may identify items on Recorded Content List 215 that match information in Change Metadata 205. For example, if Recorded Content List 215 includes the program “Friends” that was recorded at 8 p.m. on Thursday, and Change Metadata 205 includes change metadata for “Friends” from that time slot, this item is identified as a changed item.

In embodiments wherein Change Metadata 205 includes metadata for future as well as previously broadcast content, the changed item may be for a future program. If so, as typically occurs today, the changed item may be utilized by PVR 100 to alter the viewer's recording list (“Viewer Recording List 225”). This process of updating may include updating the information in Viewer Recording List 225 (illustrated as “Updated Viewer Recording List 230”) identifying when and where the requested content may now be recorded. If, however, Change Metadata 205 pertains to a previously broadcast program, then in one embodiment, upon receipt of Change Metadata 205, PVR 100 may compare Change Metadata 205 against Recorded Content List 215 and identify that the previously recorded program in the 8 p.m. time slot was not in fact the requested program. According to various embodiments of the present invention, PVR 100 may be programmed to take one or more actions to manage the previously recorded content.

In one embodiment, having identified that the previously broadcast program was erroneously recorded, PVR 100 may update the metadata for the recording on its storage device. This process of updating may include updating the information in Recorded Content List 215 (illustrated as “Updated Recorded Content List 220”) to reflect the actual program that was recorded (e.g., “The State of the Union Address” instead of “Friends”). PVR 100 may also be programmed to either automatically delete the item, or to query the viewer for an appropriate action. In the event a viewer is unable to (or desires not to) check the contents of PVR 100 on a regular basis, he or she may program PVR 100 to automatically delete the item, to conserve space on the storage device. Alternatively, if the viewer is available to (or desires to) check PVR 100 on a regular basis, PVR 100 may be programmed to present the viewer with the program change information and request instructions for how to handle the recorded item. Either embodiment of the invention enables the viewer to manage the previously broadcast content on PVR 100's storage device to ensure that only the desired recordings are stored for future viewing.

As described above, in one embodiment, Change Metadata 205 may include metadata for the entire programming schedule, including any changes since the previous download of EPG 104 containing Metadata 200. In this embodiment, the items in Recorded Content List 215 may be compared directly against Change Metadata 205, to determine whether any recorded items have changed. Alternatively, Change Metadata 205 may be compared to Metadata 200, and a list of items that have changed between the two may then be compared to Recorded Content List 215. It will be readily apparent to one of ordinary skill in the art that changes to previously broadcast recordings may be identified and compared against Recoded Content List 215 in various ways without departing from the spirit of embodiments of the present invention.

According to one embodiment, upon encountering a program change for a previously broadcast program, PVR 100 may also be programmed to search for an alternate future broadcast of the same program. Thus, in the above example, PVR 100 may search Change Metadata 205 for an alternate broadcast of the Thursday 8 p.m. showing of “Friends” and identify that the show is being broadcast at 1 a.m. on Friday morning. Once again, PVR 100 may either automatically record the alternate broadcast, or request input from the viewer to determine the viewer's choice of action.

As described above, embodiments of the present invention enable PVRs to identify content that was previously recorded in error and to manage the content. It will be readily apparent to those of ordinary skill in the art that this additional feature requires minimal changes to PVR systems, but provides significant benefits to viewers. Although EPG data may be typically large and time consuming to download, EPG change data is likely to be very small and easily downloadable. Additionally, PVRs today are already capable of comparing downloaded EPG metadata against a viewer-defined recording list to determine future programming changes. It will therefore be apparent to those of ordinary skill in the art that this ability may be extended to compare EPG change metadata against a list of previously recorded content.

According to embodiments of the present invention, EPGs may be modified to make available change metadata pertaining to previously broadcast programs to enable PVRs to compare the changed programming metadata against a list of previously recorded content on the PVR storage device. Additionally PVRs may be programmed to take specific actions (e.g., update the previously recorded content's metadata, delete the previously recorded content and/or record an alternate broadcast of the program) in response to identifying a program change for a previously broadcast program.

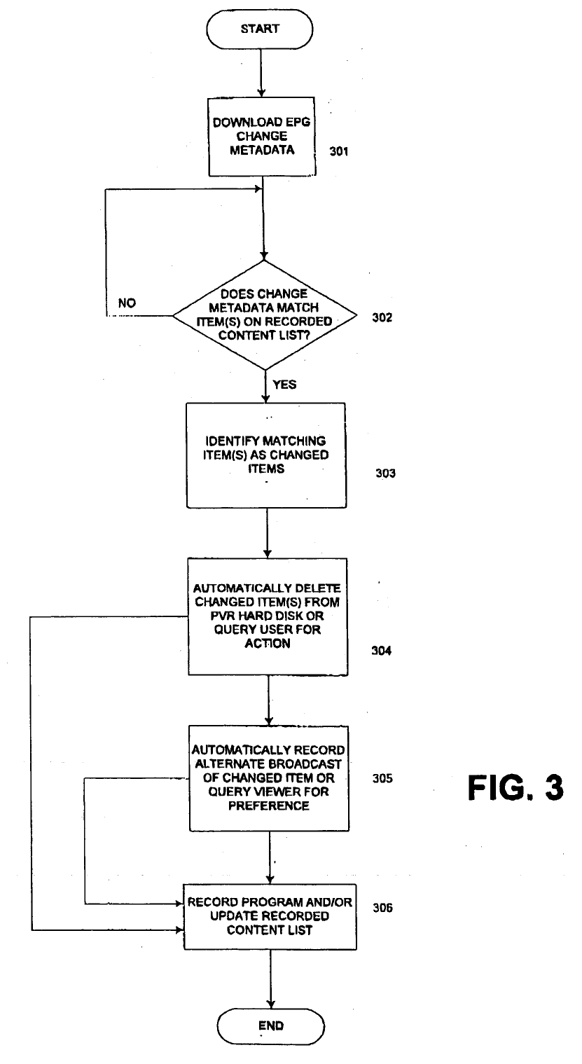

FIG. 3 is a flow chart illustrating one embodiment of the present invention. Although the following operations may be described as a sequential process, many of the operations may in fact be performed in parallel or concurrently. In addition, the order of the operations may be re-arranged without departing from the spirit of embodiments of the invention. As illustrated, EPG change metadata may be downloaded to the PVR in 301. The EPG change metadata may be compared against a list of previously recorded content in 302. If any items on the EPG change list match items on the list of previously recorded content, then at 303, the item may be identified as a changed item.

In 304, the content corresponding to the changed item may be automatically deleted from the PVR's storage device or the PVR may query the viewer for a preferred action, e.g., deleting the previously recorded content. In 305, the PVR may also be programmed to search for an alternate broadcast of the changed item and automatically record the new broadcast or query the viewer for a preference. If the alternate broadcast is recorded, the recorded content list may be updated in 306. If not, the recorded content list may still be updated in 306 with the latest EPG metadata information.

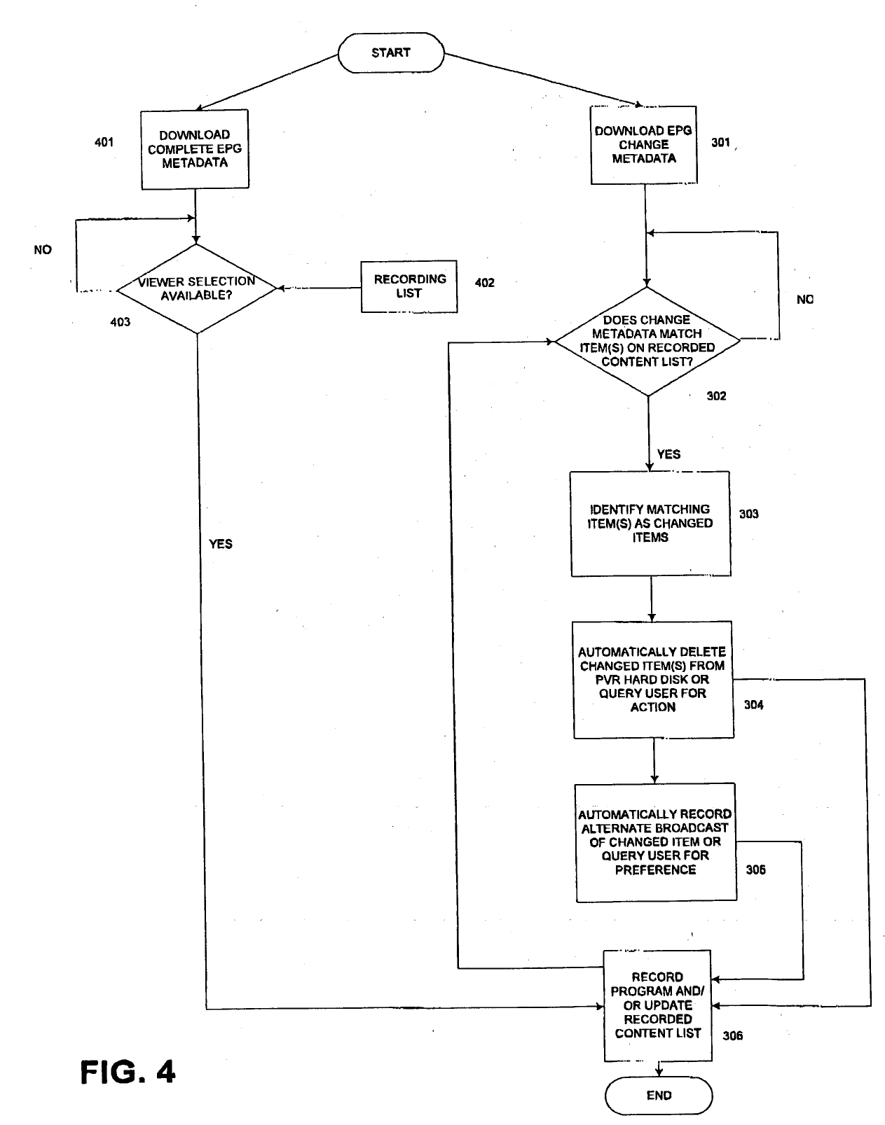

FIG. 4 is a flow chart illustrating the operation of a portion of a PVR system according to one embodiment of the present invention. As in FIG. 3, although the following operations may be described as a sequential process, many of the operations may in fact be performed in parallel or concurrently. In addition, the order of the operations may be re-arranged without departing from the spirit of embodiments of the invention. As illustrated, in 401, complete EPG metadata is downloaded to the PVR. The PVR accesses the viewer's recording list in 402 and in 403, this list is compared against the EPG metadata to determine if the viewer's selection is available. The selections from the viewer's recording list that match the EPG metadata may then be recorded, and the recorded content list may be updated in 306.

In parallel and/or concurrently with the above-described events, EPG change metadata may also be downloaded to the PVR in 301 (as previously described in relation to FIG. 3). According to one embodiment, the change metadata may be downloaded at different times than the complete EPG metadata. For example, if the PVR is programmed to download (and/or the EPG provide broadcasts) complete EPG metadata once a day, the EPG change metadata may be downloaded periodically in between the complete EPG metadata downloads. In an alternate embodiment, the PVR may be programmed to download (and/or the EPG provider may chose to broadcast) complete EPG metadata, including all EPG change metadata, periodically. In either scenario, once downloaded, the EPG change information may be compared against a list of previously recorded content in 302, and the events described in FIG. 3 above may continue unchanged.

For the purposes of illustration, the above description of various embodiments of the present invention presumes that the PVR is a data processing device. Data processing devices according to embodiments of the present invention may include, but are not limited to set-top boxes, various computer systems and/or other electronics devices. Thus, the general description of the invention above may be specifically implemented on a variety of data processing devices and across a variety of networks to achieve the same or similar results.

According to one embodiment, data processing devices may include various components capable of executing instructions to accomplish an embodiment of the present invention. For example, the data processing devices may include and/or be coupled to at least one machine-accessible medium. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals). As used herein, the term “storage device” encompasses any and all such machine-accessible media.

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus host controller such as a Universal Serial Bus (“USB”) host controller may be coupled to the bus(es) and a plurality of devices may be coupled to the USB. For example, user input devices such as a keyboard and mouse may be coupled to the data processing device for providing input data. The data processing device may additionally include a network interface (e.g., a network interface card and/or a modem) capable of coupling the device to a network (e.g., Network 103).

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method for updating previously recorded content, comprising:
downloading metadata for previously broadcast content;
comparing the metadata against a recorded content list; and
performing a predetermined action if the metadata matches an item on the recorded content list.

2. The method according to claim 1 further comprising using the metadata to update a previous version of metadata.

3. The method according to claim 1 further comprising updating the recorded content list with the metadata for the item.

4. The method according to claim 1 wherein performing the predetermined action comprises deleting the previously recorded content corresponding to the item on the recorded content list.

5. The method according to claim 1 wherein performing the predetermined action comprises querying a viewer for a preference in managing the previously recorded content corresponding to the item on the recorded content list.

6. The method according to claim 1 further comprising searching for an alternate broadcast of the item on the recorded content list.

7. The method according to claim 6 wherein searching for the alternate viewing further comprises automatically recording the alternate viewing of the item on the recorded content list.

8. The method according to claim 6 wherein searching for the alternate viewing further comprises querying a viewer for a preference in recording the alternate viewing.

9. The method according to claim 1 wherein downloading the metadata for previously broadcast content further comprises downloading only change metadata for previously broadcast content.

10. An article comprising a machine-accessible medium having stored thereon instructions that, when executed by a machine, cause the machine to:
download metadata for previously broadcast content;
compare the metadata against a recorded content list; and
perform a predetermined action if the metadata matches an item on the recorded content list.

11. The article according to claim 10 wherein the instructions further cause the machine to use the metadata to update a previous version of metadata.

12. The article according to claim 10 wherein the instructions further cause the machine to update the recorded content list with the metadata for the item.

13. The article according to claim 10 wherein the instructions, when executed by the machine, further cause the machine to delete the previously recorded content corresponding to the item on the recorded content list.

14. The article according to claim 10 wherein the instructions, when executed by the machine, further cause the machine to query a viewer for a preference in managing the previously recorded content corresponding to the item on the recorded content list.

15. The article according to claim 10 wherein the instructions, when executed by the machine, further cause the machine to search for an alternate viewing of the item on the recorded content list.

16. The article according to claim 15 wherein the instructions, when executed by the machine, further cause the machine to automatically record the alternate viewing of the item on the recorded content list.

17. The article according to claim 15 wherein the instructions, when executed by the machine, further cause the machine to query a viewer for a preference in recording the alternate viewing.

18. The article according to claim 10 wherein the instructions, when executed by the machine, further cause the machine to download only change metadata for previously broadcast content.

19. A system for updating previously recorded content, comprising:
a content source capable of being coupled to a network, the content source further capable of sending content;
a metadata source capable of being coupled to the network, the metadata source including metadata corresponding to the content on the content source, the metadata source further capable of sending the metadata; and
a personal video recorder (“PVR”) capable of downloading metadata from the metadata source corresponding to previously transmitted content, the PVR further capable of comparing the metadata against a recorded content list, the PVR additionally capable of performing a predetermined action if the metadata matches an item on the recorded content list.

20. The system according to claim 19 wherein the content source and the metadata source reside together on a data processing device.

21. The system according to claim 19 wherein the content source and the metadata source server reside on separate data processing devices.

22. The system according to claim 19 wherein the PVR is further capable of deleting the previously recorded content corresponding to the item on the recorded content list.

23. The system according to claim 19 wherein the PVR is further capable of querying a viewer for a preference in managing the previously recorded content corresponding to the item on the recorded content list.

24. The system according to claim 19 wherein the PVR is further capable of searching for an alternate viewing of the item on the recorded content list.

25. The system according to claim 24 wherein the PVR is further capable of automatically recording the alternate viewing of the item on the recorded content list.

26. The system according to claim 24 wherein the PVR is further capable of querying a viewer for a preference in recording the alternate viewing.

27. The system according to claim 19 wherein the PVR is further capable of downloading only change metadata for previously broadcast content.

28. An apparatus for updating previously recorded content, comprising:
a processor capable of downloading metadata for previously broadcast content; and
a storage device capable of storing a recorded content list, the processor further capable of comparing the metadata against the recorded content list, the processor additionally capable of performing a predetermined action if the metadata matches an item on the recorded content list.

29. The apparatus according to claim 28 wherein the processor is further capable of deleting the previously recorded content corresponding to the item on the recorded content list.

30. The apparatus according to claim 28 wherein the processor is further capable of querying a viewer for a preference in managing the previously recorded content corresponding to the item on the recorded content list.

31. The apparatus according to claim 28 wherein the processor is further capable of searching for an alternate viewing of the item on the recorded content list.

32. The apparatus according to claim 31 wherein the processor is further capable of automatically recording the alternate viewing of the item on the recorded content list.

33. The apparatus according to claim 31 wherein the processor is further capable of querying a viewer for a preference in recording the alternate viewing.

34. The apparatus according to claim 28 wherein the processor is further capable of downloading only change metadata for previously broadcast content.
